(19) United States
(12) Patent Application Publication
(10) Pub. No.: US 2017/0308668 A1
(43) Pub. Date: Oct. 26, 2017

(54) MEASUREMENT INSTRUMENT, TRANSMISSION CONTROL METHOD, MOBILE COMMUNICATIONS TERMINAL, AND COMPUTER-READABLE RECORDING MEDIUM

(71) Applicant: FUJITSU LIMITED, Kawasaki-shi (JP)

(72) Inventors: Takashi SHIMADA, Shinagawa (JP); Kasei Takano, Fujimino (JP); Masayoshi Hoshiya, Yokohama (JP); Masatsugu lsogai, Yokohama (JP)

(73) Assignee: FUJITSU LIMITED, Kawasaki-shi (JP)

(21) Appl. No.: 15/649,198

(22) Filed: Jul. 13, 2017

Related U.S. Application Data
(63) Continuation of application No. PCT/JP2016/051048, filed on Jan. 14, 2016.

(30) Foreign Application Priority Data
Jan. 15, 2015 (JP) 2015-006261

(51) Int. Cl. G06F 19/00

(52) U.S. Cl. CPC G06F 19/3418; G06F 19/323

(57) ABSTRACT

A measurement instrument includes: a processor configured to: receive registration of user identification information and a plurality of transmission destinations; and transmit a result of measurement that concerns health management measured by the measurement instrument to each of the transmission destinations registered in association with the registered user identification information.

### CROSS-REFERENCE TO RELATED APPLICATIONS

This application is a continuation application of International Application No. PCT/JP2016/051048, filed on Jan. 14, 2016 which claims the benefit of priority of the prior Japanese Patent Application No. 2015-006261, filed on Jan. 15, 2015, the entire contents of which are incorporated herein by reference.

### FIELD

The embodiments discussed herein are related to a measurement instrument, a transmission control method, a mobile communications terminal, and a computer-readable recording medium.

### BACKGROUND

In recent years, in a transportation industry for example, by attaching an operation monitoring device that monitors an operation condition to a service vehicle, operation management has been performed based on information collected from the operation monitoring device. The operation monitoring device differs, for each manufacturer or the like, in the type of information to be collected and in the format of data, for example. Thus, the operation management has been performed, by forming groups of a certain group such as each manufacturer and individually providing a management server of operation management for each group, for example. Related-art examples are described in Japanese Laid-open Patent Publication No. 2008-305050 and in International Publication Pamphlet No. WO2012/111132.

Incidentally, it is conceivable to perform the operation management by comprehending up to the health condition of a driver. For example, it is conceivable that a measurement instrument that performs measurement concerning health management transmits information concerning the health management of a driver to a management server, and that the management server performs the operation management by comprehending up to the health condition of the driver.

However, when the operation management is performed for each group, the information may be dispersed, and thus the information used for the health management in respective groups may be obtained inappropriately and the health management of the driver may be managed inadequately.

### SUMMARY

According to an aspect of the embodiments, a measurement instrument includes: a processor configured to: receive registration of user identification information and a plurality of transmission destinations; and transmit a result of measurement that concerns health management measured by the measurement instrument to each of the transmission destinations registered in association with the registered user identification information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining one example of a system configuration;

FIG. 2 is an explanatory diagram illustrating one example of an operation monitoring device;

FIG. 3 is an explanatory diagram illustrating one example of a data configuration of operation information;

FIG. 4 is an explanatory diagram illustrating one example of a data configuration of status information;

FIG. 5 is an explanatory diagram illustrating one example of a measurement instrument;

FIG. 6 is an explanatory diagram illustrating one example of a data configuration of transmission destination information;

FIG. 7 is an explanatory diagram illustrating one example of a data configuration of measurement information;

FIG. 8 is an explanatory diagram illustrating one example of a registration screen;

FIG. 9 is an explanatory diagram illustrating one example of a measurement instrument;

FIG. 10 is an explanatory diagram illustrating one example of a mobile communications terminal;

FIG. 11 is an explanatory diagram illustrating one example of a collection-object setting screen;

FIG. 12 is an explanatory diagram illustrating one example of a flow in transmission of measurement information;

FIG. 13 is an explanatory diagram illustrating one example of an operation management server;

FIG. 14 is an explanatory diagram illustrating one example of an aggregation server;

FIG. 15 is an explanatory diagram illustrating one example of a data configuration of a user DB;

FIG. 16 is an explanatory diagram illustrating one example of a data configuration of an operation DB;

FIG. 17 is an explanatory diagram illustrating one example of a display screen of travel information;

FIG. 18 is a flowchart illustrating one example of a procedure of a reception process that the measurement instrument executes;

FIG. 19 is a flowchart illustrating one example of a procedure of a transmitting process that the measurement instrument executes;

FIG. 20 is a flowchart illustrating one example of a procedure of a reception process that the mobile communications terminal executes;

FIG. 21 is a flowchart illustrating one example of a procedure of a transmitting process that the mobile communications terminal executes;

FIG. 22 is an explanatory diagram illustrating one example of a measurement instrument according to a second embodiment;

FIG. 23 is an explanatory diagram illustrating one example of a data configuration of an attribute master;

FIG. 24 is an explanatory diagram illustrating one example of a data configuration of transmission attribute information;

FIG. 25 is a diagram illustrating one example of an attribute setting screen;

FIG. 26 is an explanatory diagram schematically illustrating a system configuration; and

FIG. 27 is an explanatory diagram illustrating one example of a configuration of a computer that executes a transmission control program.

### DESCRIPTION OF EMBODIMENT

Preferred embodiments will be explained with reference to accompanying drawings. The disclosed technology, however, is not limited by the embodiments. The embodiments described in the following may be combined as appropriate within a scope of causing no contradiction.

### [a] First Embodiment

System Configuration

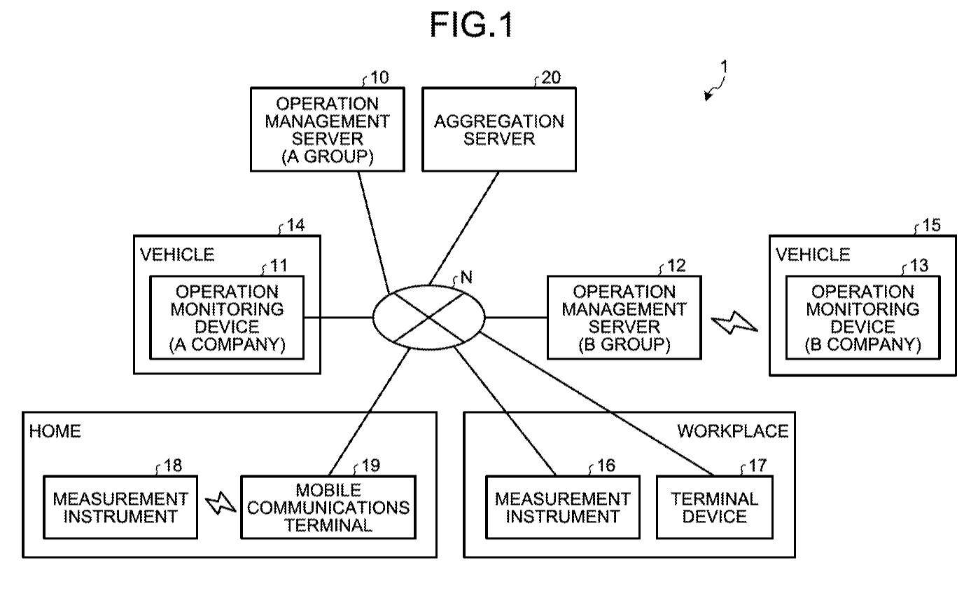

First, one example of a system that performs operation management according to a first embodiment will be described. FIG. 1 is an explanatory diagram for explaining one example of a system configuration. As illustrated in FIG. 1, a system 1 includes an operation management server 10, an operation monitoring device 11, an operation management server 12, and an operation monitoring device 13. The operation management server 10, the operation monitoring device 11, and the operation management server 12 are communicably connected to a network N. As for one form of such a network N, regardless of being wired or wireless, any type of communication network such as a mobile communication such as mobile phones, the Internet, a local area network (LAN), and a virtual private network (VPN) can be employed.

The operation monitoring device 11 and the operation monitoring device 13 are each a device that is fitted to a driver's seat of a vehicle and that monitors the operation of the equipped vehicle. The operation monitoring device 11 is a device for which the manufacturer is A company. The operation monitoring device 13 is a device for which the manufacturer is B company. The operation monitoring device 11 is fitted to a vehicle 14. The operation monitoring device 13 is fitted to a vehicle 15. In the example illustrated in FIG. 1, the vehicle 14 equipped with the operation monitoring device 11 and the vehicle 15 equipped with the operation monitoring device 13 are exemplified being one each. However, the embodiment is not limited thereto, and the vehicle 14 or the vehicle 15 can be of any desired number.

The operation management server 10 and the operation management server 12 are each a device that manages operation. The operation management server 10 and the operation management server 12 are computers such as a personal computer and a server computer, for example. The operation management server 10 and the operation management server 12 may be implemented as a single computer or may be implemented with a plurality of computers. In the first embodiment, a situation in which the operation management server 10 and the operation management server 12 are each a single computer will be described as an example.

The operation management server 10 and the operation management server 12 each perform operation management of separate groups. For example, the operation management server 10 collects, via the network N, a variety of information on each driver acquired by the operation monitoring device 11. The operation management server 10 performs, based on the collected information, operation management on an A group that includes the vehicle 14 equipped with the operation monitoring device 11 of the A company. The operation management server 12 collects a variety of information on each driver acquired by the operation monitoring device 13, via a storage medium such as a flash memory, or via wired communication or wireless communication. The operation management server 12 performs, based on the collected information, operation management on a B group that includes the vehicle 15 equipped with the operation monitoring device 13 of the B company.

The system 1 further includes a measurement instrument 16, a terminal device 17, a measurement instrument 18, a mobile communications terminal 19, and an aggregation server 20. The measurement instrument 16, the terminal device 17, the mobile communications terminal 19, and the aggregation server 20 are communicably connected to the network N.

The measurement instrument 16 is a device that is arranged in a workplace such as a transportation company and that performs measurement concerning health management, for example. The measurement instrument 16 is a sphygmomanometer, a weight scale, a clinical thermometer, an alcohol detector, and others, for example. The measurement instrument 16 measures information concerning the health management of drivers in the workplace. In the transportation industry, the measurement instrument 16 is placed in an office, and in order to perform the health management of drivers, the measurement of biological information on the drivers is performed at the time of starting the operation and at the time of ending the operation. The measurement instrument 16 receives registration of a user ID and a transmission destination. The measurement instrument 16 transmits the measured biological information to the transmission destination registered in association with the user ID.

The terminal device 17 is a terminal device such as a personal computer that is arranged in a workplace such as a transportation company, for example. The terminal device 17 is used when a staff member who is responsible for operation management of the workplace performs the operation management by accessing the operation management server 10 and the operation management server 12, for example.

The measurement instrument 18 is a device that is arranged at home of a driver and that performs measurement concerning health management, for example. The measurement instrument 18 is a sphygmomanometer, a weight scale, a clinical thermometer, a sleep meter, and others, for example. The measurement instrument 18 measures information concerning the health management of the driver at home. For example, the measurement instrument 18 measures a variety of biological information such as the blood pressure, body weight, body temperature, and sleep condition of the driver.

The mobile communications terminal 19 is a device capable of mobile communications. The mobile communications terminal 19 is a cellular phone or a smartphone that the driver owns, for example. The mobile communications terminal 19 receives the registration of a user ID and a transmission destination. The mobile communications terminal 19 further collects the biological information measured by the measurement instrument 18 via a storage medium, or via wired communication or wireless communication, for example. In the example in FIG. 1, the mobile communications terminal 19 collects the biological information collected by the measurement instrument 18 and transmits it to the transmission destination. The mobile communications terminal 19 may collect the biological information from a plurality of measurement instruments 18 and transmit it in a lump.

The aggregation server 20 is a device that aggregates the information concerning drivers. The aggregation server 20 is a computer such as a personal computer and a server computer, for example. The aggregation server 20 may be implemented as a single computer or may be implemented with a plurality of computers. In the first embodiment, a situation in which the aggregation server 20 is a single computer will be described as an example. The aggregation server 20 connects to communicate with the operation management server 10 and the operation management server 12, via the network N, for example. The aggregation server 20 collects, via the network N, a variety of information acquired by the operation management server 10 and the operation management server 12. The aggregation server 20 generates, based on the information acquired from the operation management server 10 and the operation management server 12, information concerning the operation condition of the drivers.

Configuration of Operation Monitoring Device

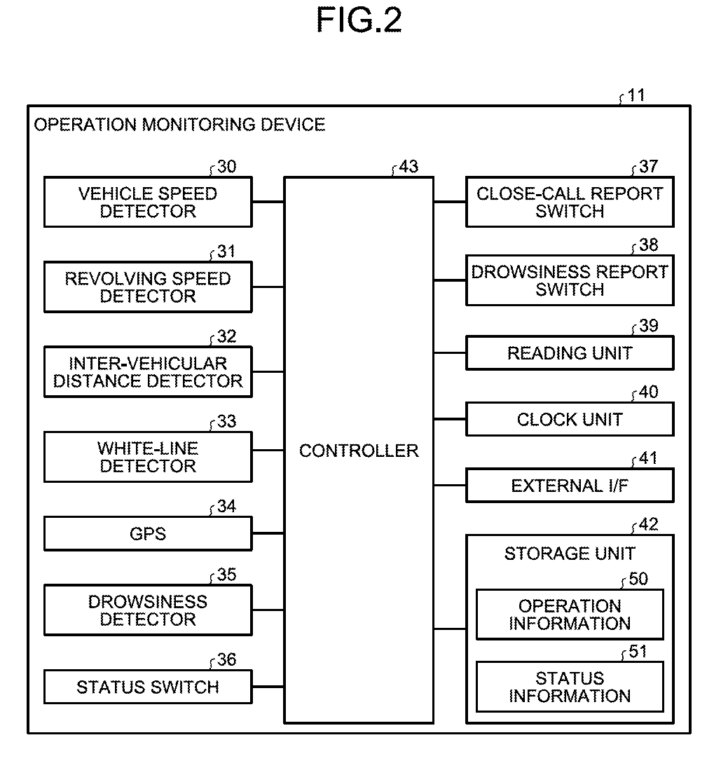

Next, the configurations of various devices will be described. First, the configuration of the operation monitoring device 11 and the operation monitoring device 13 will be described. Because the operation monitoring device 11 and the operation monitoring device 13 have substantially the same configuration, the following describes the operation monitoring device 11, and as for the operation monitoring device 13, describes different points. FIG. 2 is an explanatory diagram illustrating one example of the operation monitoring device. The operation monitoring device 11 illustrated in FIG. 2 includes a vehicle speed detector 30, a revolving speed detector 31, an inter-vehicular distance detector 32, a white-line detector 33, and a global positioning system (GPS) 34. The operation monitoring device 11 further includes a drowsiness detector 35, a status switch 36, a close-call report switch 37, a drowsiness report switch 38, a reading unit 39, a clock unit 40, an external interface (I/F) 41, a storage unit 42, and a controller 43.

The vehicle speed detector 30 is a detector that detects a vehicle speed. For example, the vehicle speed detector 30 detects, based on a signal from a speed sensor provided on the vehicle, the traveling speed of the vehicle. The revolving speed detector 31 is a detector that detects a revolving speed. For example, the revolving speed detector 31 detects, based on an ignition pulse signal of an engine, the revolving speed of the engine. The inter-vehicular distance detector 32 is a detector that detects an inter-vehicular distance. For example, the inter-vehicular distance detector 32 detects, based on a detection result by a laser sensor or a millimeter-wave radar sensor provided on the front face of the vehicle, an inter-vehicular distance to a preceding vehicle. The white-line detector 33 is a detector that detects white-line deviation of the vehicle. For example, the white-line detector 33 detects a white line that represents a traffic lane of a road by image analysis of an image captured by a camera directed toward the front of the vehicle and detects the white-line deviation of the vehicle. The GPS 34 measures, based on a signal from a GPS satellite, the current location of the vehicle. The drowsiness detector 35 is a detector that detects the occurrence of drowsiness. For example, the drowsiness detector 35 analyzes fluctuations in pulses of the driver measured by a pulse measurement unit of a contact manner in an earring type, which is attached to the ear, or of a non-contact manner and detects the drowsiness of the driver. The pulses may be detected in a method other than direct contact. For example, the drowsiness detector 35 may detect the pulses of the driver by irradiating the driver with radio waves and detecting the changes in reflection state of the radio waves.

The status switch 36 is a switch for designating the status of the driver of the vehicle, for example. The status switch 36 is a switch for designating the status such as non-designation, operating, loading, unloading, taking a break, and sleeping, for example. The close-call report switch 37 is a switch that the driver operates when the driver of the vehicle perceived a close call, for example. The drowsiness report switch 38 is a switch that the driver operates when the driver of the vehicle perceived drowsiness, for example. The reading unit 39 performs non-contact IC communication with a non-contact IC card in which a user identification (ID) is stored and, by reading out the user ID stored in the non-contact IC card, acquires the user ID. As for the non-contact IC card, a driver's license can also be used, for example. For the user ID, personal information such as a driver's license number stored in the driver's license may be used. For example, the reading unit 39 performs non-contact IC communication with the driver's license and, by reading out the personal information in the driver's license, acquires the personal information that has been read out as the user ID.

The clock unit 40 is a clock that measures the date and time of the operation monitoring device 11. The external I/F 41 is an interface that transmits and receives a variety of information to and from other devices, for example. In the operation monitoring device 11, the external I/F 41 is a wireless communication interface that performs wireless communication with the network N. In the operation monitoring device 13, the external I/F 41 is a port that inputs and outputs data to and from a storage medium such as a flash memory, a port that performs wired communication via a cable for example, or a communication interface that performs near field wireless communication.

The storage unit 42 is a storage device such as a hard disk, a solid state drive (SSD), and an optical disc. The storage unit 42 may be a semiconductor memory for which the data is rewritable such as a random access memory (RAM), a flash memory, and a non-volatile static random access memory (NVSRAM). The storage unit 42 stores therein an operating system (OS) and various programs executed by the controller 43. The storage unit 42 further stores therein a variety of information. For example, the storage unit 42 stores therein operation information 50 and status information 51.

The operation information 50 is data in which a variety of information concerning the operation of the vehicle is stored. In the operation information 50, stored are various data detected by the vehicle speed detector 30, the revolving speed detector 31, the inter-vehicular distance detector 32, the white-line detector 33, and the GPS 34.

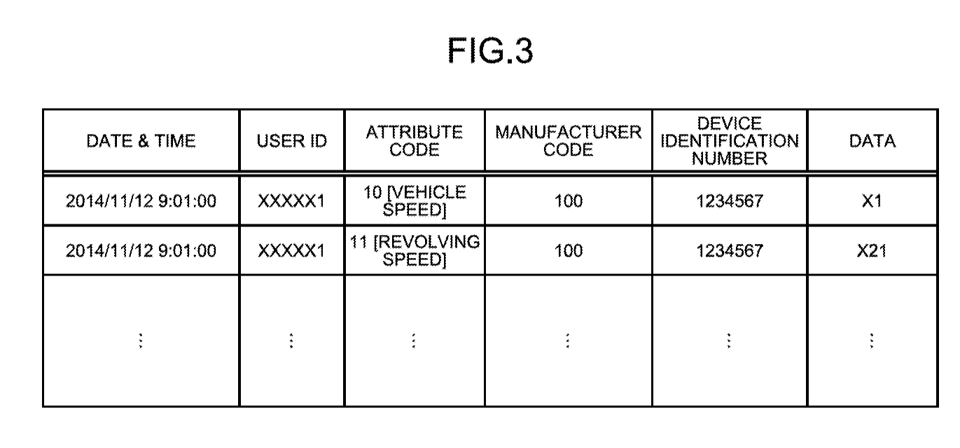

FIG. 3 is an explanatory diagram illustrating one example of a data configuration of the operation information. As illustrated in FIG. 3, the operation information 50 includes items of the date and time, user ID, attribute code, manufacturer code, device identification number, and data. The item of the date and time is an area to store the date and time at which the data was detected. The item of the user ID is an area to store identification information about the driver operating the vehicle. In the item of the user ID, stored is the user ID of the driver read out by the reading unit 39. The item of the attribute code is an area to store identification information indicative of the type of detected data. The manufacturer of the operation monitoring device 11 individually defines, for the detected data of each type, an attribute code indicative of the type. For the attribute codes, each of the manufacturers may use the same code for the same type of data, or may use different codes. In the example in FIG. 3, it is defined that the attribute code of the vehicle speed is “10” and the attribute code of the revolving speed is “11”. In the item of the attribute code, stored is an attribute code indicative of the attribute of detected data. In the following description in the first embodiment, in order to make it easy to distinguish the attribute corresponding to an attribute code, in the drawings, the attribute that an attribute code indicates is described in square brackets following the attribute code. In the example in FIG. 3, in the item of the attribute code, the attributes are described in square brackets following the attribute codes. The item of the manufacturer code is an area to store identification information that identifies the manufacturer of the operation monitoring device 11. For the manufacturer of the operation monitoring device 11, as the identification information to identify each manufacturer, a unique manufacturer code is assigned. In the item of the manufacturer code, stored is a manufacturer code assigned to the manufacturer of the operation monitoring device 11. The item of the device identification number is an area to store identification information that identifies the operation monitoring device 11. For the operation monitoring device 11, as the identification information to identify each device, for each manufacturer, a unique device identification number is assigned. In the item of the device identification number, stored is a device identification number assigned to the operation monitoring device 11. The item of the data is an item to store the detected data. In the item of the data, the detected data is stored. For example, in the case that the attribute is the vehicle speed, in the item of the data, a value of speed per hour (km/h) is stored. In the case that the attribute is the revolving speed, in the item of the data, a value of revolving speed per minute (rpm) is stored. In the case that the attribute is the inter-vehicular distance, in the item of the data, a value of distance (m) is stored. In the case that the attribute is the white-line deviation, in the item of the data, “1” is stored when the white-line deviation is detected by the white-line detector 33. In the case that the attribute is the location measured by the GPS 34, in the item of the data, the positional information measured by the GPS 34 is stored.

In the example in FIG. 3, it is indicated that the driver of the user ID “XXXXX1” is driving the vehicle 14, that the manufacturer code of the manufacturer of the operation monitoring device 11 is “100”, and that the device identification number of the operation monitoring device 11 is “1234567”. In the example in FIG. 3, it is further indicated that the vehicle speed was detected at 9:01:00 on Nov. 12, 2014, and that the detected vehicle speed is X1 (km/h). In the example in FIG. 3, it is further indicated that the revolving speed was detected at 9:01:00 on Nov. 12, 2014, and that the detected revolving speed is X21 (rpm).

The status information 51 is data in which a variety of information concerning the status of the driver is stored. In the status information 51, stored is various data detected by the drowsiness detector 35, the status switch 36, the close-call report switch 37, and the drowsiness report switch 38.

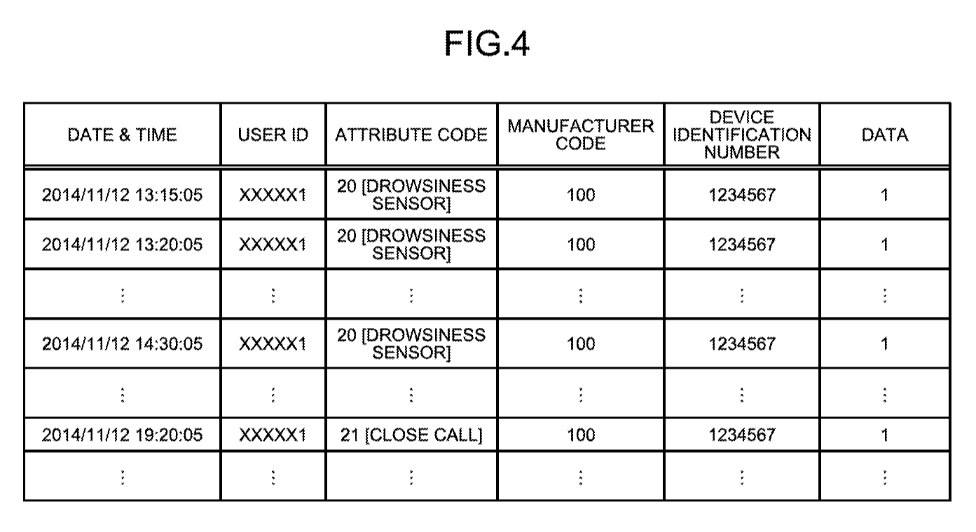

FIG. 4 is an explanatory diagram illustrating one example of a data configuration of the status information. The status information 51 has the data configuration the same as that of the operation information 50. In the example in FIG. 4, it is defined that the attribute code of the drowsiness detection by the drowsiness detector 35 is “20” and the attribute code of the close-call report by the close-call report switch 37 is “21”. In the item of the attribute code, stored is an attribute code indicative of the attribute of the detected data. In the item of the data, the detected data is stored. For example, in the case that the attribute is the drowsiness detection, in the item of the data, “1” is stored when the drowsiness is detected by the drowsiness detector 35. In the case that the attribute is the operation status, in the item of the data, a value corresponding to the status of the status switch 36 is stored. In the case that the attribute is the close-call report, in the item of the data, “1” is stored when the close-call report switch 37 is turned on. In the case that the attribute is the drowsiness report, in the item of the data, “1” is stored when the drowsiness report switch 38 is turned on.

In the example in FIG. 4, it is indicated that the driver of the user ID “XXXXX1” is driving the vehicle 14, that the manufacturer code of the manufacturer of the operation monitoring device 11 is “100”, and that the device identification number of the operation monitoring device 11 is “1234567”. Furthermore, in the example in FIG. 4, it is indicated that the drowsiness was detected by the drowsiness detector 35 at 13:15:05 on Nov. 12, 2014. In the example in FIG. 4, it is further indicated that the drowsiness was detected by the drowsiness detector 35 at 13:20:05 on Nov. 12, 2014. In the example in FIG. 4, it is further indicated that the drowsiness was detected by the drowsiness detector 35 at 14:30:05 on Nov. 12, 2014. In the example in FIG. 4, it is further indicated that there was a close-call report by the close-call report switch 37 at 19:20:05 on Nov. 12, 2014. The data configurations of the operation information 50 and the status information 51 illustrated in FIGS. 3 and 4, respectively, are one example, and are not limited thereto. For example, the operation information 50 and the status information 51 may be configured as a single file. The operation information 50 and the status information 51 may be configured as separate files for each attribute of the data. The operation information 50 and the status information 51 may be in a data configuration in which the data of each item is delimited in certain order by certain delimiter characters. The operation information 50 and the status information 51 may be in a data configuration that indicates the attribute of the data by using tags or the like.

The controller 43 controls a whole of the operation monitoring device 11. The controller 43 stores various data detected by the vehicle speed detector 30, the revolving speed detector 31, the inter-vehicular distance detector 32, and the white-line detector 33 in the operation information 50. The controller 43 further stores various data detected by the drowsiness detector 35, the status switch 36, the close-call report switch 37, and the drowsiness report switch 38 in the status information 51.

Configuration of Measurement Instrument

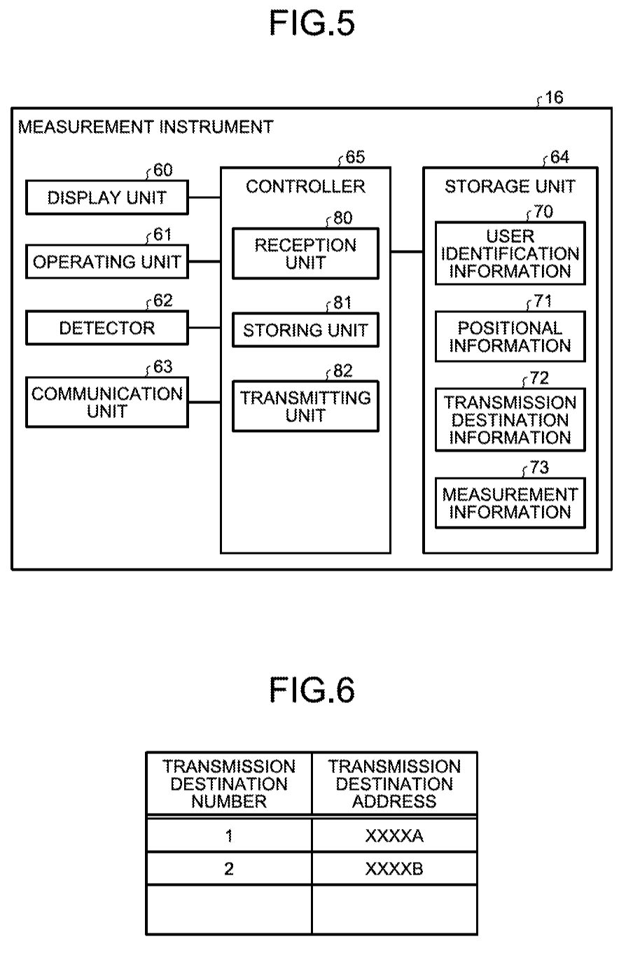

Next, the configuration of the measurement instrument 16 will be described. FIG. 5 is an explanatory diagram illustrating one example of the measurement instrument. The measurement instrument 16 illustrated in FIG. 5 includes a display unit 60, an operating unit 61, a detector 62, a communication unit 63, a storage unit 64, and a controller 65.

The display unit 60 is a display device capable of displaying a variety of information. The operating unit 61 is an input device that receives various operating inputs. For example, the operating unit 61 receives the registration of a user ID and of a transmission destination of biological information to be measured.

The detector 62 detects biological information on the user. For example, when the measurement instrument 16 is a pulsimeter, the detector 62 is a pulse measurement unit, which measures the pulse rate of the user, of a contact manner in an earring type, which is attached to the ear, or of a non-contact manner. When the measurement instrument 16 is a sphygmomanometer, the detector 62 is a blood-pressure measurement unit that measures a blood pressure value of the user. For example, when the measurement instrument 16 is a weight scale, the detector 62 is a weight measurement unit that measures the body weight of the user. For example, when the measurement instrument 16 is a clinical thermometer, the detector 62 is a body-temperature measurement unit that measures the body temperature of the user. For example, when the measurement instrument 16 is a measurement instrument that measures an alcohol concentration in exhaled breath, the detector 62 is an alcohol measurement unit that measures the alcohol concentration in the exhaled breath of the user. When the measurement instrument 16 is a sleep measurement instrument, the detector 62 is a measurement unit that measures the quality of sleep of the user. The detector 62 may detect a plurality of types of biological information on the user. For example, when the measurement instrument 16 is a sphygmomanometer and the detector 62 is a measurement unit of a contact manner, the detector 62 may detect the pulse rate and the body temperature, in addition to the blood pressure.

The communication unit 63 is a communication interface that performs wireless communication or wired communication with the network N, for example. The storage unit 64 is a storage device such as a hard disk, an SSD, and an optical disc. The storage unit 64 may be a semiconductor memory for which the data is rewritable. The storage unit 64 stores therein an OS and various programs executed by the controller 65. The storage unit 64 further stores therein a variety of information. For example, the storage unit 64 stores therein user identification information 70, positional information 71, transmission destination information 72, and measurement information 73.

The user identification information 70 is data in which the user ID is stored. The positional information 71 is data in which the positional information on the measurement instrument 16 is stored. The transmission destination information 72 is data in which the transmission destination of detected biological information is stored.

FIG. 6 is an explanatory diagram illustrating one example of a data configuration of the transmission destination information. The transmission destination information 72 includes items of a transmission destination number and a transmission destination address. The item of the transmission destination number is an area to store a number that identifies the transmission destination. The measurement instrument 16 is capable of registering a plurality of transmission destinations. In the item of the transmission destination number, the number that identifies the transmission destination is numbered and stored, in registered order. The item of the transmission destination address is an area to store the address of the transmission destination. The address may be any information as long as it is indicative of a transmission destination of data. For example, the address may be a network address such as an Internet protocol (IP) address or may be a uniform resource locator (URL).

In the example in FIG. 6, the transmission destination of the transmission destination number “1” indicates that the address of the transmission destination is “XXXXA”. In the example in FIG. 6, the transmission destination of the transmission destination number “2” indicates that the address of the transmission destination is “XXXXB”.

The measurement information 73 is data in which the biological information measured by the detector 62 is stored.

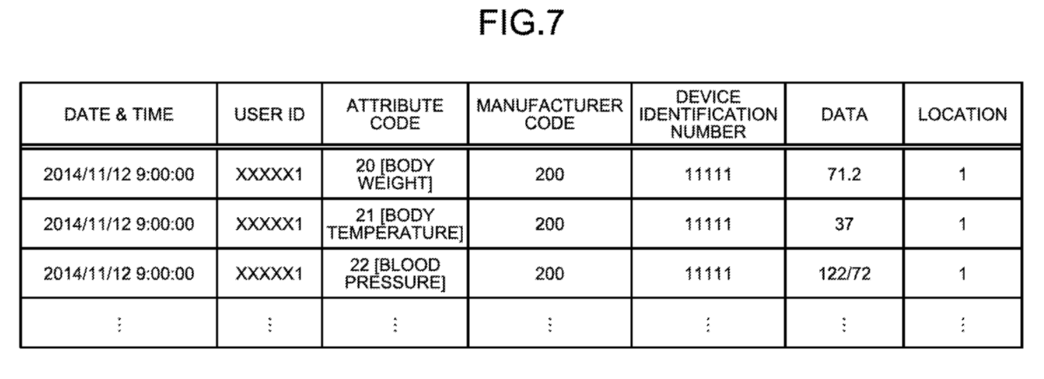

FIG. 7 is an explanatory diagram illustrating one example of a data configuration of the measurement information. The measurement information 73 is in a data configuration similar to that of the above-described operation information 50 and the status information 51, and includes items of the date and time, user ID, attribute code, manufacturer code, device identification number, data, and location. In the item of the date and time, stored is the date and time at which the biological information was measured by the detector 62. In the item of the user ID, stored is the user ID stored in the user identification information 70. In the item of the attribute code, stored is an attribute code indicative of the attribute of detected data. As for the attribute code, the manufacturer of the measurement instrument 16 individually defines an attribute code indicative of the type for the various data that is detected. In the example in FIG. 7, it is defined that the attribute code of body weight is “20”, that the attribute code of body temperature is “21”, and that the attribute code of blood pressure is “22”. In the item of the manufacturer code, stored is a manufacturer code assigned to the manufacturer of the measurement instrument 16. In the item of the device identification number, stored is a device identification number assigned to the measurement instrument 16. In the item of the data, the detected data is stored. For example, in the case that the attribute is body weight, in the item of the data, a value of body weight (kg) is stored. In the case that the attribute is body temperature, in the item of the data, a value indicative of body temperature is stored. In the case that the attribute is blood pressure, in the item of the blood pressure, values of diastolic blood pressure and systolic blood pressure are stored being delimited by “/”. In the item of the location, stored is the positional information on the measurement instrument 16 stored in the positional information 71.

In the example in FIG. 7, it is indicated that the biological information on the user of the user ID “XXXXX1” was measured, that the manufacturer code of the manufacturer of the measurement instrument 16 is “200”, and that the device identification number of the measurement instrument 16 is “11111”. In the example in FIG. 7, it is further indicated that the body weight, body temperature, and blood pressure were detected at 9:00 on Nov. 12, 2014, and that the body weight is 71.2 (kg), the body temperature is 37 degrees, and the blood pressure is 122 (diastolic blood pressure)/72 (systolic blood pressure).

The controller 65 controls a whole of the measurement instrument 16. As for the controller 65, an electronic circuit such as a central processing unit (CPU) and a micro processing unit (MPU) or an integrated circuit such as an application specific integrated circuit (ASIC) and a field programmable gate array (FPGA) can be employed. The controller 65 includes an internal memory for storing therein programs, in which various processing procedures are defined, and control data, and executes a variety of processing by them. The controller 65, as various programs operate, functions as various processing units. For example, the controller 65 includes a reception unit 80, a storing unit 81, and a transmitting unit 82.

The reception unit 80 performs various types of reception. For example, the reception unit 80 causes the display unit 60 to display a registration screen, and receives the registration of the user ID, the positional information, and the transmission destination from the operating unit 61.

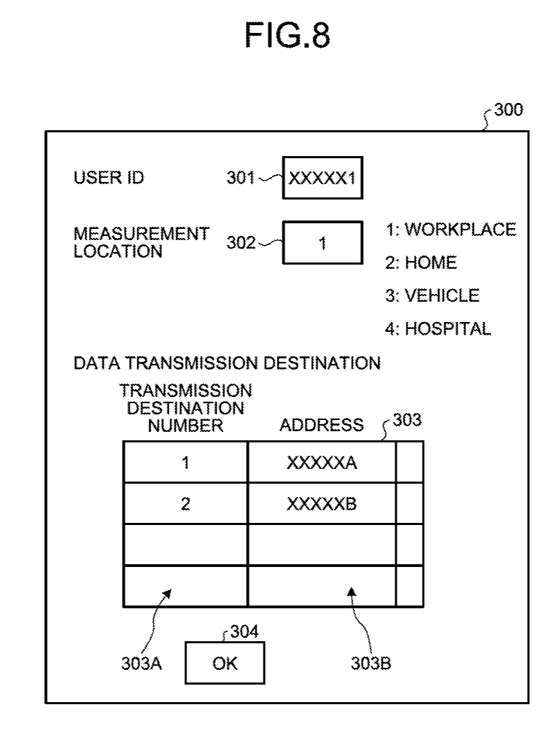

FIG. 8 is an explanatory diagram illustrating one example of the registration screen. As illustrated in FIG. 8, a registration screen 300 is provided with an input area 301 for inputting the user ID, an input area 302 for inputting the location of the measurement instrument 16, an input area 303 for inputting the transmission destination, and an OK button 304.

The input area 301 is defined as an area for inputting the user ID of a user for whom the biological information is detected. The input area 302 is defined as an area for inputting a code indicative of the location in which the measurement instrument 16 is installed. The code indicative of the location is defined as “1” at workplace, “2” at home, “3” in the vehicle, and “4” in a hospital.

The input area 303 is provided with an area 303A that displays the transmission destination number and an area 303B in which inputting the address of the transmission destination is allowed. In the input area 303, when an address is input into the area 303B, a transmission destination number that is numbered in sequence is newly displayed in the area 303A of the record corresponding thereto.

By using the operating unit 61, the user inputs into the registration screen 300 the user ID, the code indicative of the location that the measurement instrument 16 is installed, and the address of the transmission destination, and selects the OK button 304.

The reception unit 80, when the OK button 304 is selected, stores in the storage unit 64 each piece of information that was input into the registration screen 300. For example, the reception unit 80 stores in the user identification information 70 the user ID that was input into the input area 301. The reception unit 80 further stores in the positional information 71 the code indicative of the location that was input into the input area 302. The reception unit 80 further stores in the transmission destination information 72 the address of the transmission destination that was input into the input area 303, in association with the transmission destination number. The user ID may be read from a non-contact IC card in which the user ID is stored. For example, by providing a reading unit capable of reading a non-contact IC card on the reception unit 80, the reception unit 80 may execute non-contact IC communication with the non-contact IC card at the reading unit of the reception unit 80 and, by reading out the user ID stored in the non-contact IC card, store it in the user identification information 70.

The storing unit 81 stores the biological information detected by the detector 62 in the measurement information 73. For example, when the biological information is measured, the storing unit 81 stores it in the measurement information 73, in association with the measurement date and time, the attribute code of the biological information, the user ID of the user identification information 70, the manufacturer code, the device identification number, and the code of the positional information 71.

The transmitting unit 82 transmits the measured biological information to the transmission destination registered in the transmission destination information 72. For example, the transmitting unit 82 transmits as the transmission data the measurement information 73 to the address of the transmission destination registered in the transmission destination information 72.

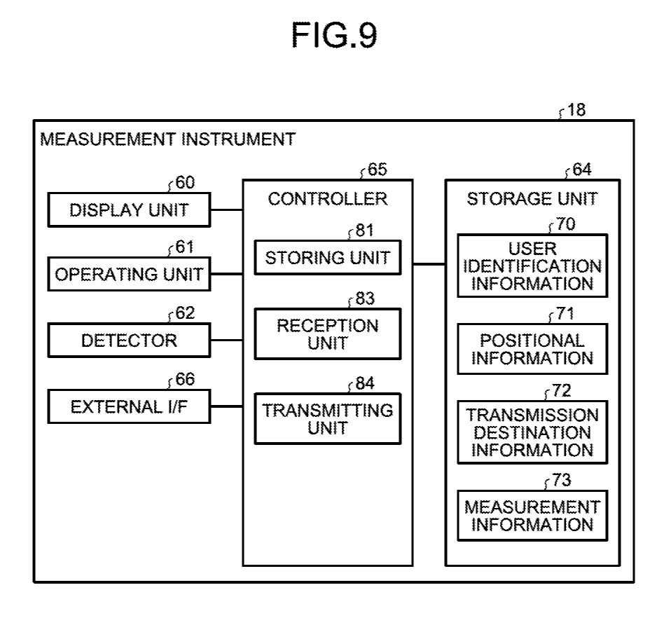

Next, the configuration of the measurement instrument 18 will be described. FIG. 9 is an explanatory diagram illustrating one example of the measurement instrument. Because the configuration of the measurement instrument 18 is substantially the same as that of the measurement instrument 16 illustrated in FIG. 5, the same reference signs will be given to the same portions and different portions will mainly be described. The measurement instrument 18 illustrated in FIG. 9 includes an external I/F 66 in place of the communication unit 63.

The external I/F 66 is an interface that transmits and receives a variety of information to and from other devices. For example, the external I/F 66 is a port that inputs and outputs data to and from a storage medium such as a flash memory, a port that performs wired communication via a cable and others, or a communication interface that performs near field wireless communication.

The detector 62 detects biological information on the user. For example, when the measurement instrument 18 is a sleep measurement instrument, the detector 62 is a measurement unit that measures the quality of sleep of the user.

A reception unit 83 receives the registration of the user ID and the positional information from the operating unit 61. The reception unit 83 stores the received user ID in the user identification information 70 and stores the received positional information in the positional information 71.

The transmitting unit 84 transmits the measurement information 73 to other devices via the external I/F 66. For example, when being operable to perform communication with the mobile communications terminal 19 via the external I/F 66, the transmitting unit 84 transmits the measurement information 73 to the mobile communications terminal 19 in response to a request from the mobile communications terminal 19.

Configuration of Mobile Communications Terminal

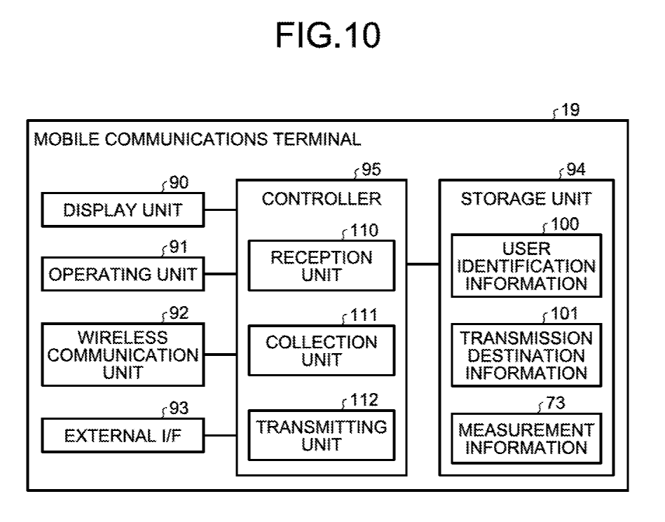

Next, the configuration of the mobile communications terminal 19 will be described. FIG. 10 is an explanatory diagram illustrating one example of the mobile communications terminal. The mobile communications terminal 19 illustrated in FIG. 10 includes a display unit 90, an operating unit 91, a wireless communication unit 92, an external I/F 93, a storage unit 94, and a controller 95.

The display unit 90 is a display device capable of displaying a variety of information. The operating unit 91 is an input device that receives various operating inputs. For example, the operating unit 91 receives the registration of the user ID of a user, whose biological information is collected from the measurement instrument 18, and of a transmission destination of the collected biological information.

The wireless communication unit 92 is a communication interface that performs wireless communication or wired communication with the network N, for example. The external I/F 93 is an interface that transmits and receives a variety of information to and from other devices. For example, the external I/F 93 is a port that inputs and outputs data to and from a storage medium such as a flash memory, a port that performs wired communication via a cable and others, or a communication interface that performs near field wireless communication.

The storage unit 94 is a storage device such as a hard disk, an SSD, and an optical disc. The storage unit 94 may be a semiconductor memory for which the data is rewritable. The storage unit 94 stores therein an OS and various programs executed by the controller 95. The storage unit 94 further stores therein a variety of information. For example, the storage unit 94 stores therein user identification information 100, transmission destination information 101, and the measurement information 73.

The user identification information 100 is data in which the user ID of a user whose biological information is collected from the measurement instrument 18 is stored. The transmission destination information 101 is data in which the transmission destination of detected biological information is stored.

The controller 95 controls a whole of the mobile communications terminal 19. As for the controller 95, an electronic circuit such as a CPU and an MPU or an integrated circuit such as an ASIC and an FPGA can be employed. The controller 95 includes an internal memory for storing therein programs, in which various processing procedures are defined, and control data, and executes a variety of processing by them. The controller 95, as various programs operate, functions as various processing units. For example, the controller 95 includes a reception unit 110, a collection unit 111, and a transmitting unit 112.

The reception unit 110 performs various types of reception. For example, the reception unit 110 causes the display unit 90 to display a collection-object setting screen, and receives the registration of the user ID and the transmission destination from the operating unit 91.

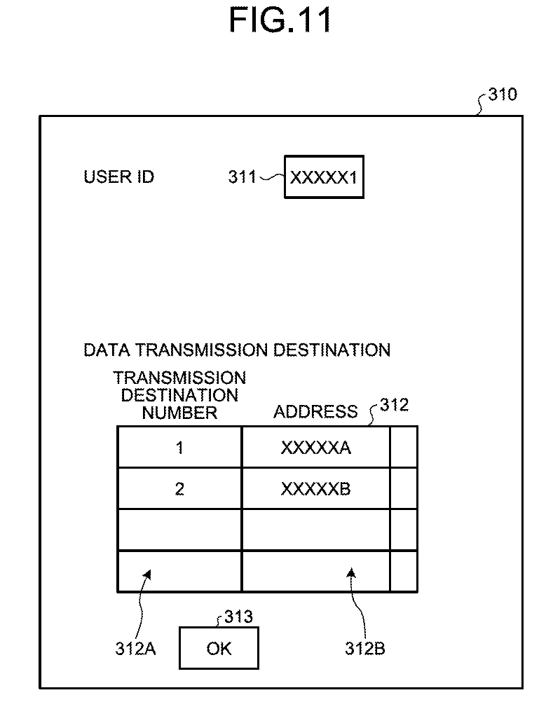

FIG. 11 is an explanatory diagram illustrating one example of the collection-object setting screen. As illustrated in FIG. 11, a collection-object setting screen 310 is provided with an input area 311 for inputting the user ID, an input area 312 for inputting the transmission destination, and an OK button 313.

The input area 311 is defined as an area for inputting the user ID of a user who is the object of collecting the biological information. The input area 312 is provided with an area 312A that displays the transmission destination number and an area 312B in which inputting the address of the transmission destination is allowed. In the input area 312, when an address is input into the area 312B, a transmission destination number that is numbered in sequence is displayed in the area 312A of the record corresponding thereto.

By using the operating unit 91, the user inputs into the collection-object setting screen 310 the user ID of the user, whose biological information is collected from the measurement instrument 18, and the address of the transmission destination of the collected biological information, and selects the OK button 313.

The reception unit 110, when the OK button 313 is selected, stores in the storage unit 94 each piece of information that was input into the collection-object setting screen 310. For example, the reception unit 110 stores in the user identification information 100 the user ID that was input into the input area 311. The reception unit 110 further stores in the transmission destination information 101 the address of the transmission destination that was input into the input area 312, in association with the transmission destination number. The user ID may be read from a non-contact IC card in which the user ID is stored. For example, by providing a reading unit capable of reading a non-contact IC card on the reception unit 110, the reception unit 110 may execute non-contact IC communication with the non-contact IC card at the reading unit of the reception unit 110 and, by reading out the user ID stored in the non-contact IC card, store it in the user identification information 100.

The collection unit 111 collects the biological information from the measurement instrument 18. For example, in the case of collecting the measurement information 73 from a storage medium, when being accessible to the storage medium via the external I/F 93, the collection unit 111 searches the storage medium and collects the measurement information 73 that is associated with the user ID of the user identification information. For example, in the case of collecting the measurement information 73 via wired communication or wireless communication, when being operable to communicate with the measurement instrument 18 via the external I/F 93, the collection unit 111 collects the measurement information 73 that is associated with the user ID of the user identification information 100 from the measurement instrument 18. When collecting it by wired communication or wireless communication, the collection unit 111 may collect it by accessing the storage unit 64 via the external I/F 93. The collection unit 111 may be configured to transmit a user ID to the measurement instrument 18 and to cause the measurement instrument 18 to transmit the measurement information 73 corresponding to the user ID. The collection unit 111 stores the collected measurement information 73 in the storage unit 94.

The transmitting unit 112 transmits as the transmission data the measurement information 73 that is stored in the storage unit 94 to the address of the transmission destination registered in the transmission destination information 101.

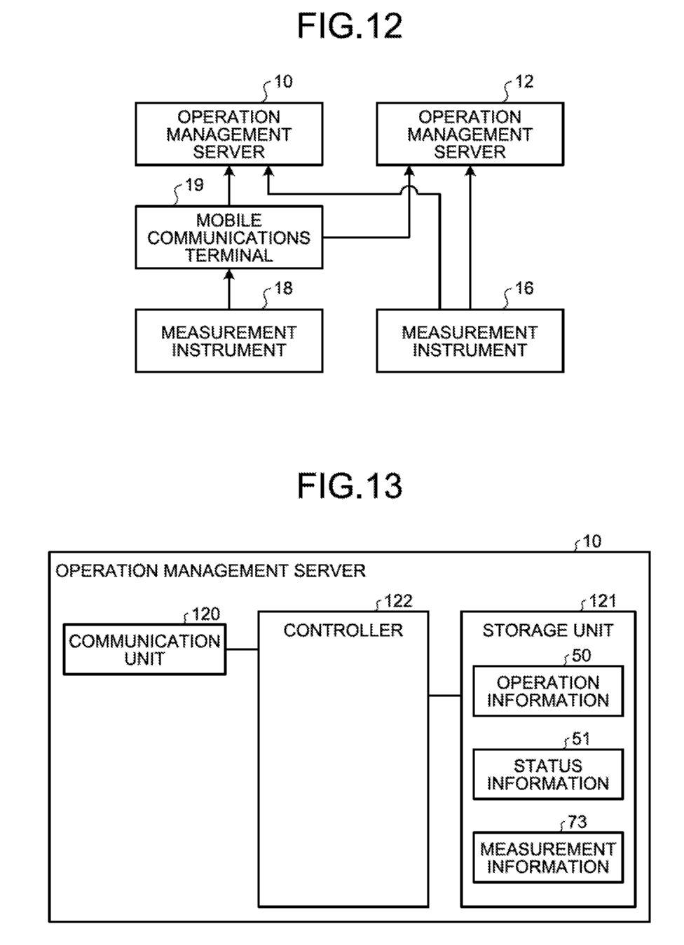

FIG. 12 is an explanatory diagram illustrating one example of a flow in transmission of measurement information. For example, when the operation management server 10 and the operation management server 12 are registered as the transmission destination in the transmission destination information 72 and the transmission destination information 101, the measurement information 73 in the measurement instrument 16 is directly transmitted to the operation management server 10 and the operation management server 12. The measurement information 73 in the measurement instrument 18 is transmitted to the operation management server 10 and the operation management server 12 via the mobile communications terminal 19. The mobile communications terminal 19 may collect the measurement information 73 from a plurality of measurement instruments 18 and transmit it in a lump to the operation management server 10 and the operation management server 12.

In the operation management server 10, stored are the operation information 50 and the status information 51 collected from the operation monitoring device 11 and the measurement information 73 collected from the measurement instrument 16 and the measurement instrument 18. In the operation management server 12, stored are the operation information 50 and the status information 51 collected from the operation monitoring device 13 and the measurement information 73 collected from the measurement instrument 16 and the measurement instrument 18.

Configuration of Operation Management Server

Next, the configuration of the operation management server 10 and the operation management server 12 will be described. Because the operation management server 10 and the operation management server 12 have substantially the same configuration, the following describes the operation management server 10.

FIG. 13 is an explanatory diagram illustrating one example of the operation management server. The operation management server 10 illustrated in FIG. 13 includes a communication unit 120, a storage unit 121, and a controller 122. The communication unit 120 is a communication interface that performs wireless communication or wired communication with the network N, for example. The storage unit 121 is a storage device such as a hard disk, an SSD, and an optical disc. The storage unit 121 may be a semiconductor memory for which the data is rewritable. In the storage unit 121, stored are the operation information 50, the status information 51, and the measurement information 73. The controller 122 controls a whole of the operation management server 10. Based on the operation information 50, the status information 51, and the measurement information 73 stored in the storage unit 121, the controller 122 executes a variety of processing concerning the operation management.

Configuration of Aggregation Server

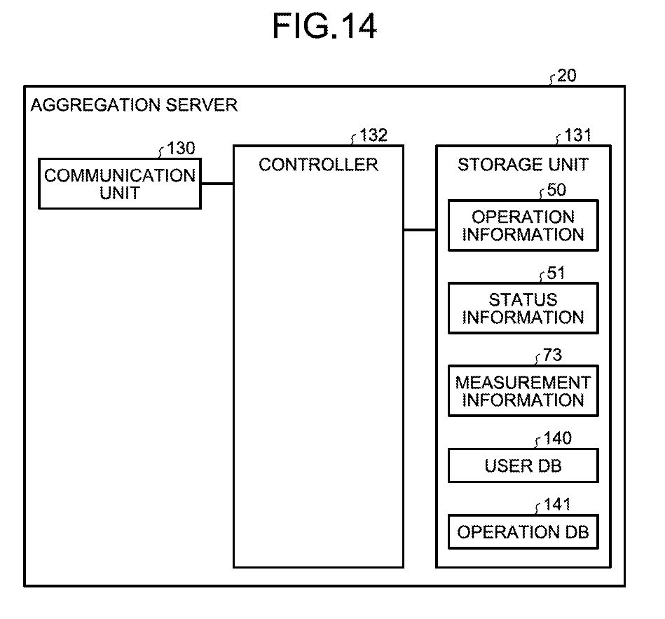

Next, the configuration of the aggregation server 20 will be described. FIG. 14 is an explanatory diagram illustrating one example of the aggregation server. The aggregation server 20 illustrated in FIG. 14 includes a communication unit 130, a storage unit 131, and a controller 132. The communication unit 130 is a communication interface that performs wireless communication or wired communication with the network N, for example. The storage unit 131 is a storage device such as a hard disk, an SSD, and an optical disc. The storage unit 131 may be a semiconductor memory for which the data is rewritable. In the storage unit 131, stored are the operation information 50, the status information 51, and the measurement information 73. In the storage unit 131, further stored are a user database (DB) 140 and an operation DB 141.

The controller 132 controls a whole of the aggregation server 20. The controller 132 collects the operation information 50, the status information 51, and the measurement information 73 from the operation management server 10 and the operation management server 12, and stores the collected operation information 50, the status information 51, and the measurement information 73 in the storage unit 131.

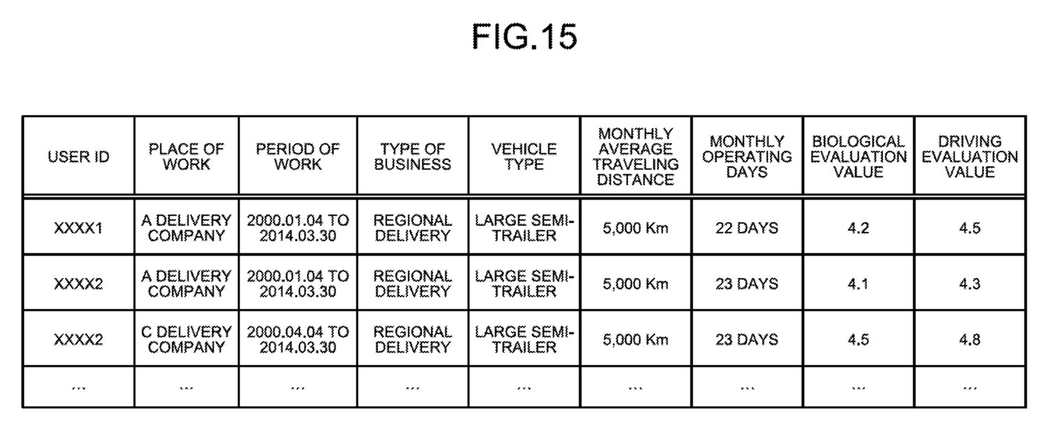

The user DB 140 is data in which personal information on a driver is stored for each identification information that identifies the driver. FIG. 15 is an explanatory diagram illustrating one example of a data configuration of the user DB. The user DB 140 illustrated in FIG. 15 stores therein the data of respective items of the user name, sex, age, license type, travel distance, driver history, qualification information, and service vehicle type, in association with each user ID.

The controller 132, by the input operation from the terminal device 17 installed at the workplace of a transportation company and the like, updates and registers the data of the respective items of the user name, sex, age, license type, travel distance, driver history, qualification information, and service vehicle type in the user DB 140, for example.

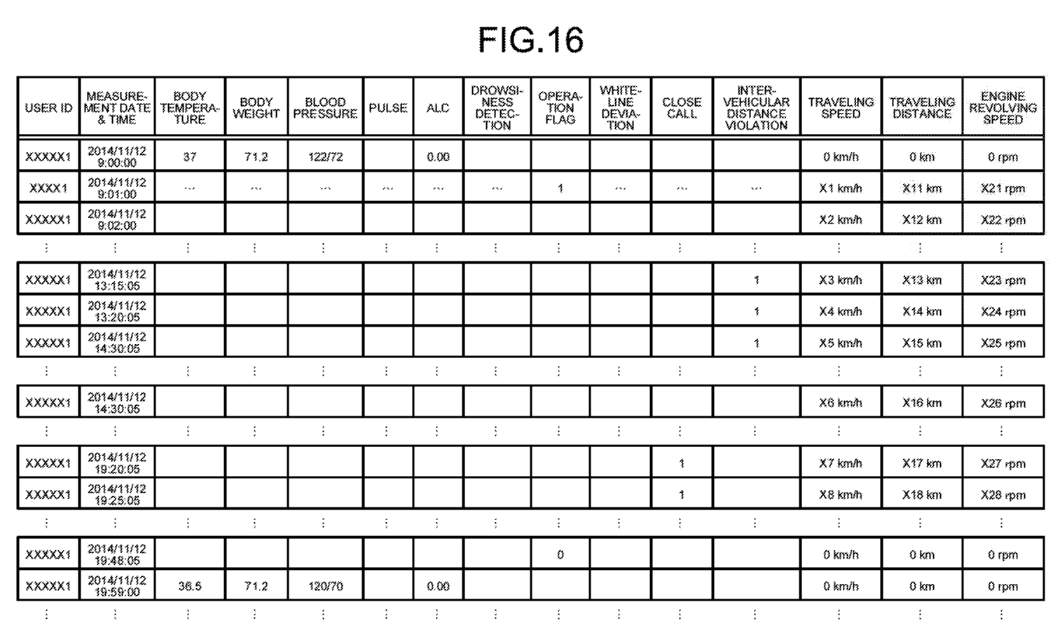

The operation DB 141 is data in which the information concerning drivers is aggregated and stored for each user ID that identifies the driver. FIG. 16 is an explanatory diagram illustrating one example of a data configuration of the operation DB. The operation DB 141 stores therein the data of respective items of the body temperature, body weight, blood pressure, pulse, and ALC, in association with each user ID and measurement date and time. The ALC is an alcohol concentration in the exhaled breath of the driver, for example. Furthermore, the operation DB 141 stores therein the data of respective items of the drowsiness detection, operation flag, white-line deviation, close call, and inter-vehicular distance violation, in association with each user ID and measurement date and time. The operation DB 141 further stores therein the data of the respective items of the traveling speed, traveling distance, and engine revolving speed, in association with each user ID and measurement date and time.

Based on the operation information 50, the status information 51, and the measurement information 73 stored in the storage unit 131, the controller 132 aggregates the data for each user ID and measurement date and time, and generates the operation DB 141. Note that, when there are a plurality of data of the same attribute at the same measurement date and time, the controller 132 aggregates any one piece of data. The controller 132 determines that it is an inter-vehicular distance violation when the inter-vehicular distance is equal to or less than a certain threshold.

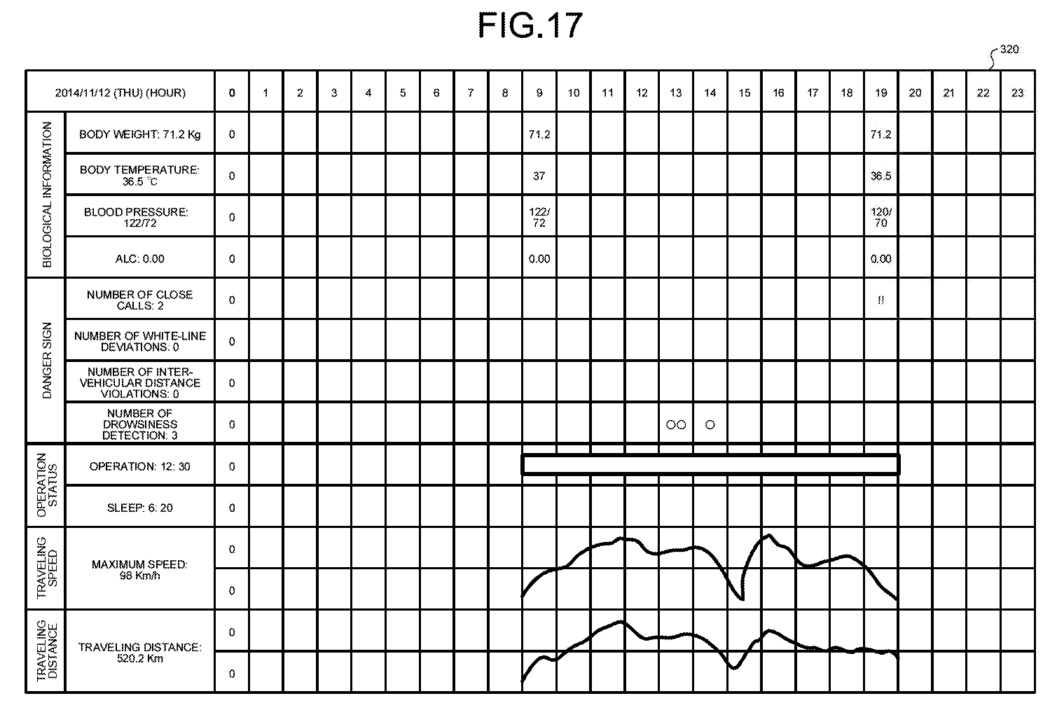

The controller 132, in response to a display request, for which the travel information on the user ID of a designated driver and on the designated date is displayed, from the terminal device 17 via the network N, reads out from the operation DB 141 the information on the user ID of the designated driver and on the designated date. The controller 132 then provides, based on the read-out information, a display screen, in which the travel information is displayed, to the terminal device 17 of the display request source. Consequently, in the terminal device 17, a display screen 320 that displays the travel information is displayed. FIG. 17 is an explanatory diagram illustrating one example of the display screen of travel information. The display screen 320 illustrated in FIG. 17 displays the travel information for one day on Nov. 12, 2014 concerning a certain designated driver. The travel information displays the biological information, danger sign, operation status, traveling speed, and traveling distance. In the display items of the biological information, the body weight, body temperature, blood pressure, and ALC are displayed, for example. The controller 132 refers to the measurement date and time in the operation DB 141 corresponding to the designated user ID and designated date, searches for the body temperature, body weight, blood pressure, and ALC, and sets the search result thereof as the biological information.

In the display items of the danger sign, the number of close calls, the number of white-line deviations, the number of inter-vehicular distance violations, and the number of drowsiness detection are displayed. The controller 132 refers to the measurement date and time in the operation DB 141 corresponding to the designated user ID and designated date, searches for the data of the items of the drowsiness detection, white-line deviation, close call, and inter-vehicular distance violation, and sets the search result thereof as the danger sign. In the display items of the danger sign, the presence of occurrence of the close call, white-line deviation, inter-vehicular distance violation, and drowsiness detection is displayed in units of time, and a total number of occurrences on the designated date is also displayed.

In the display items of the operation status, the operating time of the driver's vehicle is displayed in a bar chart form, and the operating time and the sleep time are also displayed. The controller 132 searches for the operation flag in the operation DB 141 corresponding to the designated user ID and the date and time, and displays the search result thereof as the operation status.

In the display item of the traveling speed, the traveling speed of the driver's vehicle for the designated date is displayed in a graph form, and the maximum speed on the designated date is also displayed. The controller 132 refers to the measurement date and time in the operation DB 141 corresponding to the designated user ID and designated date, searches for the traveling speed, and displays the search result thereof as the traveling speed.

In the display item of the traveling distance, the traveling distance of the driver's vehicle for the designated date is displayed in a graph form, and a total traveling distance on the designated date is also displayed. The controller 132 refers to the measurement date and time in the operation DB 141 corresponding to the designated user ID and designated date, searches for the traveling distance, and displays the search result thereof as the traveling distance.

That is, the controller 132 provides, in response to a display request of travel information on the designated driver and designated date from the terminal device 17, the travel information, such as the biological information, danger sign, operation status, traveling speed, and traveling distance of the designated driver and the designated date, to the terminal device 17 of the display request source. As a result, the user of the terminal device 17 of the display request can visually recognize the display screen 320 illustrated in FIG. 17 and, by designating the driver and the date and time, recognize the travel information on the designated driver and designated date in units of time.

Sequence of Processing

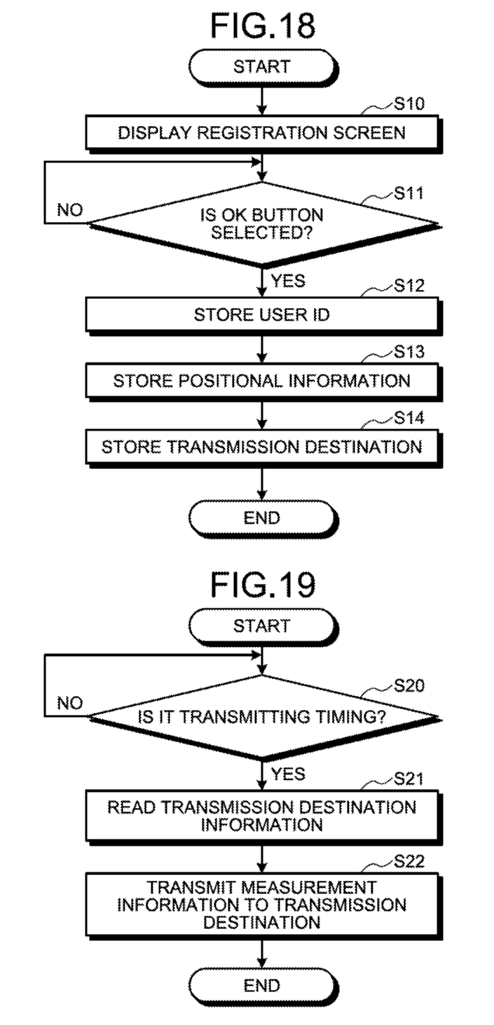

Next, a variety of processing executed in the system 1 in the first embodiment will be described. First, a sequence of a reception process in which the measurement instrument 16 in the first embodiment receives the registration of a user ID and a transmission destination will be described. FIG. 18 is a flowchart illustrating one example of a procedure of the reception process that the measurement instrument executes. This reception process is executed at a certain timing, for example, the timing of having performed a certain operation of specifying the display of the registration screen 300 from the operating unit 61.

As illustrated in FIG. 18, the reception unit 80 causes the display unit 60 to display the registration screen 300 (S10), and receives the registration of the user ID, the positional information, and the transmission destination from the operating unit 61. The reception unit 80 determines whether the OK button 304 has been selected (S11). When the OK button 304 is not yet selected (No at S11), the process returns to S11 again and waits for the selection of the OK button 304.

Meanwhile, when the OK button 304 has been selected (Yes at S11), the reception unit 80 stores in the user identification information 70 the user ID that was input into the input area 301 of the registration screen 300 (S12). The reception unit 80 stores in the positional information 71 the code indicative of the location that was input into the input area 302 of the registration screen 300 (S13). The reception unit 80 stores in the transmission destination information 72 the address of the transmission destination that was input into the input area 303 of the registration screen 300, in association with the transmission destination number (S14), and ends the processing.

Next, a sequence of a transmitting process in which the measurement instrument 16 in the first embodiment transmits the measurement information 73 to the transmission destination registered in the transmission destination information 72 will be described. FIG. 19 is a flowchart illustrating one example of a procedure of the transmitting process executed by the measurement instrument. This transmitting process is repeatedly executed each time the processing is ended.

As illustrated in FIG. 19, the transmitting unit 82 determines whether it is a certain transmitting timing (S20). This certain transmitting timing may be at the timing of fixed intervals such as date and time, may be at the timing at which the transmission is specified from the user or the operation management server 10 or 12, or may be at the timing at which the biological information is measured. When it is not the transmitting timing (No at S20), the process returns to S20 again.

Meanwhile, when it is the transmitting timing (Yes at S20), the transmitting unit 82 reads the transmission destination information 72 (S21). The transmitting unit 82 transmits the measurement information 73 to the transmission destination registered in the transmission destination information 72 (S22), and ends the processing.

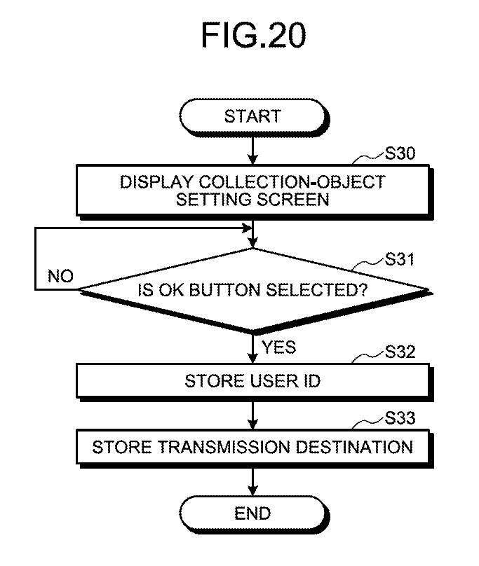

Next, a sequence of a reception process in which the mobile communications terminal 19 in the first embodiment receives the registration of a user ID and a transmission destination will be described. FIG. 20 is a flowchart illustrating one example of a procedure of the reception process that the mobile communications terminal executes. This reception process is executed at a certain timing, for example, the timing of having performed a certain operation of specifying the display of the collection-object setting screen 310 from the operating unit 91.

As illustrated in FIG. 20, the reception unit 110 causes the display unit 90 to display the collection-object setting screen 310 (S30), and receives the registration of the user ID and the transmission destination from the operating unit 91. The reception unit 110 determines whether the OK button 313 has been selected (S31). When the OK button 313 is not yet selected (No at S31), the process returns to S31 again and waits for the selection of the OK button 313.

Meanwhile, when the OK button 313 has been selected (Yes at S31), the reception unit 110 stores in the user identification information 100 the user ID that was input into the input area 311 of the collection-object setting screen 310 (S32). The reception unit 110 stores in the transmission destination information 101 the address of the transmission destination that was input into the input area 312 of the collection-object setting screen 310, in association with the transmission destination number (S33), and ends the processing.

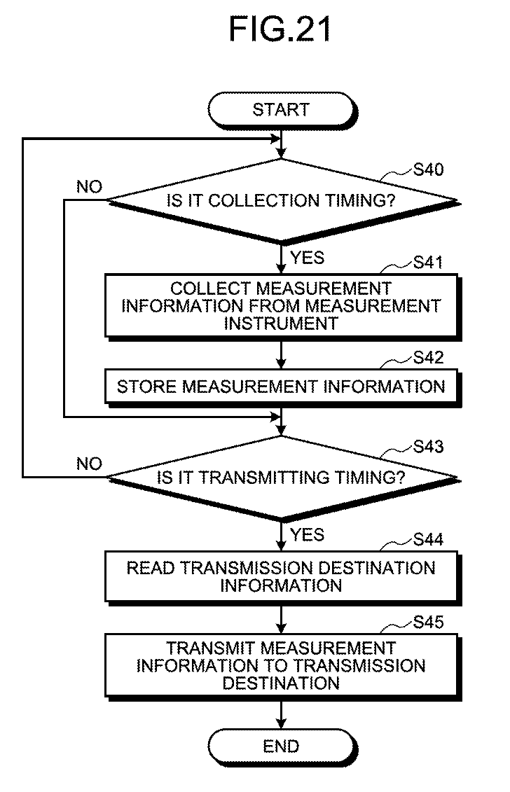

Next, a sequence of a transmitting process in which the mobile communications terminal 19 in the first embodiment collects the measurement information 73 and transmits it to the transmission destination registered in the transmission destination information 101 will be described. FIG. 21 is a flowchart illustrating one example of a procedure of the transmitting process that the mobile communications terminal executes. This transmitting process is repeatedly executed each time the processing is ended.

As illustrated in FIG. 21, the transmitting unit 112 determines whether it is a certain collection timing (S40). This certain collection timing may be the timing of being operable to access a storage medium via the external I/F 93, or may be the timing of being operable to communicate with the measurement instrument 18 via the external I/F 93. When it is not the transmitting timing (No at S40), the process moves to S43 which will be described later. When it is the transmitting timing (Yes at S40), the collection unit 111 collects the measurement information 73 that is associated with the user ID of the user identification information 100, via the external I/F 93 (S41). The collection unit 111 stores the collected measurement information 73 in the storage unit 94 (S42).

The transmitting unit 112 determines whether it is a certain transmitting timing (S43). This certain transmitting timing may be at the timing of fixed intervals such as date and time, or may be at the timing at which the transmission is specified from the user or the operation management server 10 or 12. When it is not the transmitting timing (No at S43), the process returns to the above-described S40.

Meanwhile, when it is the transmitting timing (Yes at S43), the transmitting unit 112 reads the transmission destination information 101 (S44). The transmitting unit 112 transmits the measurement information 73 to the transmission destination registered in the transmission destination information 101 (S45), and ends the processing.

### Advantageous Effects

As described in the foregoing, the measurement instrument 16 in the first embodiment receives the registration of a user ID and a plurality of transmission destinations. The measurement instrument 16 transmits the result of measurement that concerns health management by the measurement instrument 16 to each of the transmission destinations registered in association with the registered user ID. Accordingly, even when the operation management is performed in a plural manner, the measurement instrument 16 can provide information used for the health management.

Furthermore, the measurement instrument 16 in the first embodiment transmits the transmission data including the attribute of measurement result, identification information on a manufacturer of the measurement instrument, a device identification number of the measurement instrument, measurement time, a measurement result, and a measurement location to the transmission destination. Accordingly, from the received transmission data, the transmission destination can identify the attribute of the measurement result, the manufacturer of the measurement instrument, the device identification number of the measurement instrument, the measurement time, and the measurement location.

The measurement instrument 16 in the first embodiment receives the registration of a user ID by reading a non-contact IC card in which the user ID is stored. Accordingly, the measurement instrument 16 can reduce the trouble of inputting the user ID. The measurement instrument 16 can, by reading the non-contact IC card, measure and transmit the biological information on the legitimate user who owns the non-contact IC card.

The mobile communications terminal 19 in the first embodiment collects, from the measurement instrument 18 that stores therein the measurement result concerning health management in association with the user ID, the measurement result that is stored in association with the user ID of the user identification information 100. The mobile communications terminal 19 transmits the collected measurement result to the transmission destination in association with the identification information indicative of the measurement instrument of an acquisition source of the measurement result and in association with the user ID of the user identification information 100. Accordingly, the mobile communications terminal 19 can collect only the measurement result associated with the user ID of the user identification information 100 from the measurement instrument 18, and transmit the measurement result to the transmission destination. Because the mobile communications terminal 19 collects only the measurement result associated with the user ID of the user identification information 100 from the measurement instrument 18, the mobile communications terminal 19 can be restrained from collecting unnecessary measurement results.

The mobile communications terminal 19 in the first embodiment collects, from each of a plurality of measurement instruments 18, the measurement results stored in association with the user ID of the user identification information 100. The mobile communications terminal 19 transmits the collected measurement result to the transmission destination in association with the identification information indicative of each measurement instrument of an acquisition source of the measurement result and in association with the user ID of the user identification information 100. Accordingly, the mobile communications terminal 19 can transmit in a lump the measurement results measured by the respective measurement instruments 18 to the transmission destination.

### [b] Second Embodiment

Next, a second embodiment will be described. Because the configurations of the system 1, the operation management servers 10 and 12, the operation monitoring devices 11 and 13, and the aggregation server 20 in the second embodiment are the same as those of the first embodiment, the descriptions thereof are omitted.

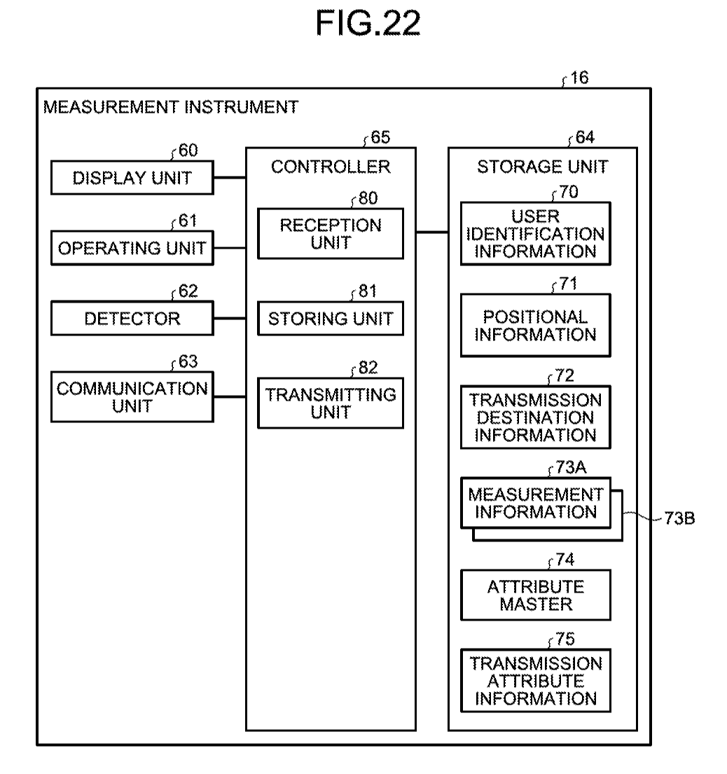

In the system 1 in the second embodiment, the measurement instruments 16 and 18 are capable of a plurality of types of measurement concerning health management, and receives, for each of the transmission destinations, the registration that defines which type of measurement result of the measured information is the measurement result to be a transmitting object. In the system 1 in the second embodiment, because the functions added to the measurement instruments 16 and 18 are the same, the following describes the measurement instrument 16. FIG. 22 is an explanatory diagram illustrating one example of the measurement instrument in the second embodiment. As for the portions the same as those of the first embodiment, the identical reference signs are given to, and the portions being different will mainly be described.

The measurement instrument 16 in the second embodiment further stores an attribute master 74 and transmission attribute information 75 in the storage unit 64. The attribute master 74 is data in which the attribute of data is stored in association with an attribute code.

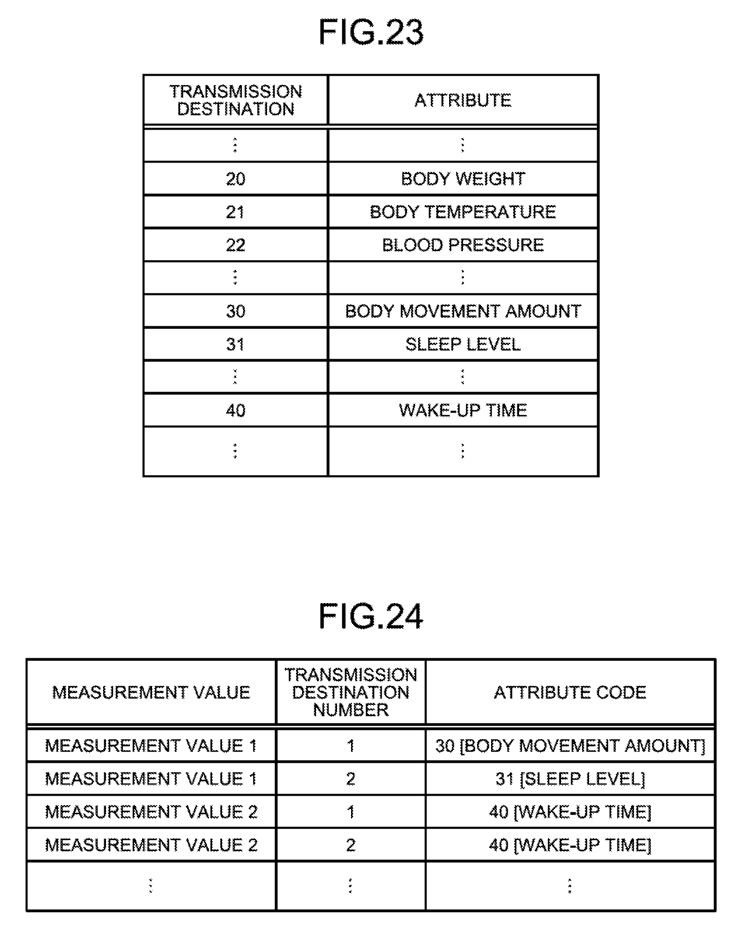

FIG. 23 is an explanatory diagram illustrating one example of a data configuration of the attribute master. The attribute master 74 includes items of the attribute code and attribute. The item of the attribute code is an area to store the attribute code of the attribute that can be designated by the measurement instrument 16. The item of the attribute is an area that the name of the attribute corresponding to the attribute code is stored.

In the example in FIG. 23, it is indicated that the attribute of the attribute code “30” is “body movement amount”. In the example in FIG. 23, it is further indicated that the attribute of the attribute code “31” is “sleep level”. In the example in FIG. 23, it is further indicated that the attribute of the attribute code “40” is “wake-up time”.

The transmission attribute information 75 is data that stores therein the attribute to be added to the measurement result for each transmission destination.

FIG. 24 is an explanatory diagram illustrating one example of a data configuration of the transmission attribute information. The transmission attribute information 75 includes items of the measurement value, transmission destination number, and attribute code. The item of the measurement value is an area to store identification information that identifies the measurement value measured in the measurement instrument 16. The example in FIG. 24 illustrates a situation in which the measurement instrument 16 obtains two measurement results of a measurement value 1 and a measurement value 2. The measurement instrument 16 in the second embodiment measures the body movement amount as the measurement value 1 and measures the wake-up time as the measurement value 2. For example, the measurement instrument 16 measures the body movement amount by the detection of vibrations or the detection of changes in a reflection state by emitting infrared rays, ultrasonic waves, and others. For example, the measurement instrument 16 further measures, as the wake-up time, the time at which the body movement is no longer detected for a certain period for the first time after the body movement was once detected. Note that the type and the number of measurement values that the measurement instrument 16 measures are mere examples, and the embodiment is not limited thereto.

The item of the transmission destination number is an area to store the transmission destination number of the transmission destination that is to be associated with. The item of the attribute code is an area to store the attribute code that is to be associated with the transmission destination and the measurement value.

In the example in FIG. 24, it is indicated that the measurement value 1 is associated with the attribute code of “30” for the transmission destination of the transmission destination number “1”, and is associated with the attribute code of “31” for the transmission destination of the transmission destination number “2”. In the example in FIG. 24, it is further indicated that the measurement value 2 is associated with the attribute code of “40” for the transmission destinations of the transmission destination numbers “1” and “2”.

The reception unit 80 causes the display unit 60 to display an attribute setting screen, and receives the registration of the attribute to be associated with the measurement result for each transmission destination from the operating unit 61.

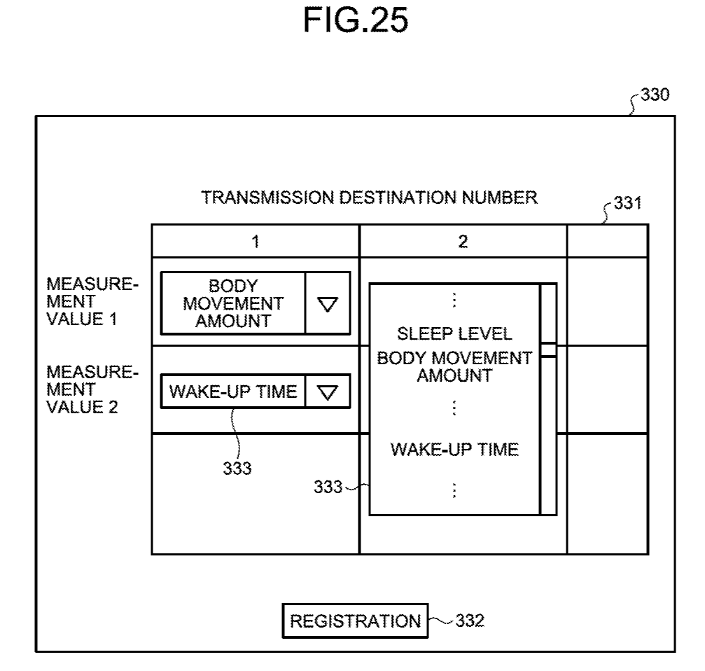

FIG. 25 is a diagram illustrating one example of the attribute setting screen. As illustrated in FIG. 25, an attribute setting screen 330 is provided with an area 331 in which the attribute to be associated with a measurement result is designated for each transmission destination, and a registration button 332.

In the area 331, the area is divided into a table format, and as the item in the longitudinal direction, the type of measurement value is displayed, and as the item in the lateral direction, the transmission destination number of the registered transmission destination is displayed. In the area 331, a combo box 333 is further displayed in each area of the table format. In the combo box 333, when selected, the name of the attribute stored in the attribute master 74 is displayed.

By using the operating unit 61, the user designates, by selecting the attribute in each combo box 333 in the area 331 of the attribute setting screen 330, the attribute to be associated with the measurement result for each transmission destination. In the example in FIG. 25, the measurement value 1 is designated with “body movement amount” as the attribute to be associated with the transmission destination of the transmission destination number “1”. In the example in FIG. 25, the measurement value 2 is designated with “wake-up time” as the attribute to be associated with the transmission destination of the transmission destination number “1”. When having completed designating the attribute to be associated with the measurement result for each transmission destination on the attribute setting screen 330, the user selects the registration button 332.

The reception unit 80, when the registration button 332 is selected, stores in the transmission attribute information 75 the attribute to be associated with the measurement result for each transmission destination designated on the attribute setting screen 330.

The storing unit 81 stores the biological information detected by the detector 62 in a separate file for each transmission destination. For example, when transmitting to two transmission destinations, the measurement instrument 16 stores the biological information in separate files as measurement information 73A and measurement information 73B corresponding to the transmission destinations. Furthermore, when storing the biological information in the measurement information 73A and the measurement information 73B, the storing unit 81 associates, based on the transmission attribute information 75, the biological information with the attribute code for each transmission destination.

The transmitting unit 82 transmits the measured biological information to the transmission destination registered in the transmission destination information 72. For example, the transmitting unit 82 transmits, to the respective transmission destinations, the measurement information 73A or 73B corresponding thereto.

Accordingly, the measurement instrument 16 can transmit the measured biological information with the attribute corresponding to the transmission destination. Furthermore, even when it is not of the type of measurement result corresponding to the transmission destination, the measurement instrument 16 can transmit by applying the measurement result of high correlation.

### Advantageous Effects

As in the foregoing, the measurement instrument 16 in the second embodiment is capable of a plurality of types of measurement concerning health management. The measurement instrument 16 receives, for each of the transmission destinations, registration defining which type of measurement result is the measurement result to be a transmitting object. The measurement instrument 16 transmits, to each of the transmission destinations, the measurement result as the measurement result of the type that has been registered. Accordingly, the measurement instrument 16 can transmit the measurement result corresponding to the transmission destination. Furthermore, even when it is not of the type of measurement result corresponding to the transmission destination, the measurement instrument 16 can transmit by applying the measurement result of high correlation.

The above-described added function can be applied to the mobile communications terminal 19 in the same manner. That is, the mobile communications terminal 19 may receive the designation of the measurement type to be associated with the measurement result from the operating unit 91 and, when transmitting the collected measurement result to the transmission destination, transmit the information indicative of the designated measurement type in association with the measurement result. Accordingly, the mobile communications terminal 19 can transmit the measured biological information with the attribute corresponding to the transmission destination. Furthermore, even when it is not of the type of measurement result corresponding to the transmission destination, the mobile communications terminal 19 can transmit by applying the measurement result of high correlation.

### [c] Third Embodiment

The embodiments concerning the disclosed devices have been described so far. However, the disclosed technology may be implemented in various different forms in addition to the above-described embodiments. Thus, the following describes other embodiments that are included in the present invention.

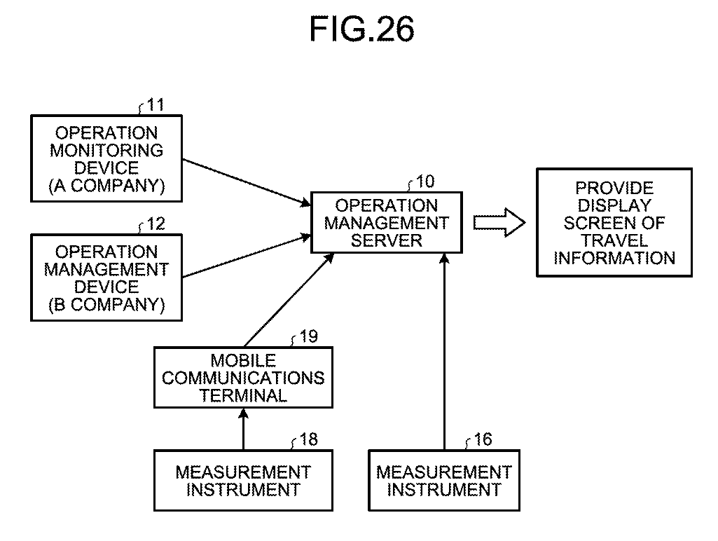

For example, in the above-described embodiments, exemplified has been a situation in which the operation management server is provided for each group and the operation detection is carried out for each group. However, the embodiments are not limited thereto. For example, the operation management may be performed by a single management source. FIG. 26 is an explanatory diagram schematically illustrating a system configuration. The example in FIG. 26 illustrates a situation in which the operation management server 10 serving as a management source performs the operation management. The operation management server 10 collects the operation information 50 and the status information 51 on each driver from the operation monitoring device 11 and the operation monitoring device 13. The operation management server 10 further collects the measurement information 73 from the measurement instrument 16, and collects the measurement information 73 from the measurement instrument 18 via the mobile communications terminal 19. The operation management server 10 then aggregates the collected operation information 50, the status information 51, and the measurement information 73, and provides the display screen 320 that displays the travel information.

Furthermore, in the above-described embodiments, exemplified has been a situation in which the mobile communications terminal 19 relays the measurement result from the measurement instrument 18 to the operation management server 10 and the operation management server 12. However, the embodiments are not limited thereto, and can be modified as appropriate. For example, the mobile communications terminal 19 that the driver owns may collect a variety of information such as the operation information 50 from the operation monitoring device 13, and transmit the collected various information to the operation management server 12. The mobile communications terminal 19 may further transmit the collected various information in association with the user identification information.

In the above-described embodiments, exemplified has been a situation in which the user ID is registered to the measurement instrument 16, the measurement instrument 18, and the mobile communications terminal 19 from the screen. However, the embodiments are not limited thereto, and can be modified as appropriate. For example, a specific user ID may be set for the measurement instrument 16, the measurement instrument 18, and the mobile communications terminal 19. For example, the user ID of an owning user may be set for the measurement instrument 16, the measurement instrument 18, and the mobile communications terminal 19.

In the above-described embodiments, exemplified has been a situation in which the code indicative of the location is used as the positional information on the measurement instrument 16 and the measurement instrument 18. However, the embodiments are not limited thereto, and can be modified as appropriate. For example, the positional information on the measurement instrument 16 and the measurement instrument 18 may be data indicative of the location by coordinates. For example, by providing a GPS on the measurement instrument 16 and the measurement instrument 18, the data indicative of the location by latitude, longitude, and the like may be used as the positional information. When transmitting the measurement result of the measurement instrument 18 via the mobile communications terminal 19, the mobile communications terminal 19 may transmit, as the information on the location in the measurement information 73, the positional information on which the measurement result has been collected. For example, the mobile communications terminal 19 may transmit, to a transmission destination, the measurement information 73 in which the data indicative of the location by the coordinates of latitude, longitude, and the like that were detected by the GPS provided on the mobile communications terminal 19 is used as the information on the location in the measurement information 73.

In the above-described embodiments, exemplified has been a situation in which the measurement instrument 16 and the measurement instrument 18 transmit the measurement result concerning health management in association with the user ID registered from the screen. However, the embodiments are not limited thereto, and can be modified as appropriate. For example, the measurement instrument 16 stores in the storage unit 64 the characteristics of the measurement result of a user in association with the user identification information on the user. The measurement instrument 16 may then transmit a measurement result concerning health management in association with the user identification information on the user whose measurement result is the closest to the characteristics of measurement result stored in the storage unit 64. For example, when the measurement instrument 16 is used by a plurality of users and measures the biological information, the measurement instrument 16 associates the previous measurement results of biological information on the respective users with the user IDs and stores them in the storage unit 64 as the characteristics of the respective users. Then, when the biological information is measured, the measurement instrument 16 may compare the measured biological information with the previous biological information on the respective users stored in the storage unit 64, and associate the measured biological information with the user ID of the user whose biological information is the closest. Accordingly, even when a plurality of users use the measurement instrument 16 to measure the biological information, the measurement instrument 16 can accurately associate the measured biological information with the user ID of the user who has measured the biological information.

In the above-described embodiments, exemplified has been a situation in which the measurement instrument 16 and the mobile communications terminal 19 transmit the biological information to a plurality of transmission destinations. However, the embodiments are not limited thereto, and can be modified as appropriate. For example, the measurement instrument 16 and the mobile communications terminal 19 may be configured to selectively transmit the biological information to the transmission destination, for each attribute of the biological information. For example, the measurement instrument 16 and the mobile communications terminal 19 receive, for each attribute, the registration of the transmission destination. A plurality of transmission destinations may be designated. The measurement instrument 16 and the mobile communications terminal 19 may store the attribute of a transmitting object for each transmission destination, and may transmit data by extracting the data of the attribute of the transmitting object from the measurement information 73 for each transmission destination.

The respective constituent elements of the various devices illustrated are functionally conceptual, and do not necessarily need to be physically configured as illustrated in the drawings. In other words, the specific states of distribution or integration of the various devices are not limited to those illustrated, and the whole or a part thereof can be configured by being functionally or physically distributed or integrated in any unit, depending on various types of loads and usage. For example, the respective processing units of the reception unit 80, the storing unit 81, and the transmitting unit 82 in the measurement instrument 16 may be integrated as appropriate. Furthermore, the respective processing units of the reception unit 110, the collection unit 111, and the transmitting unit 112 in the mobile communications terminal 19 may be integrated as appropriate. The processing of the respective processing units may be separated into the processing of a plurality of processing units as appropriate. Moreover, the whole or any part of the processing functions performed in the respective processing units can be implemented by a CPU and a program analyzed and executed by the CPU, or can be implemented as hardware by wired logic.

Transmission Control Program

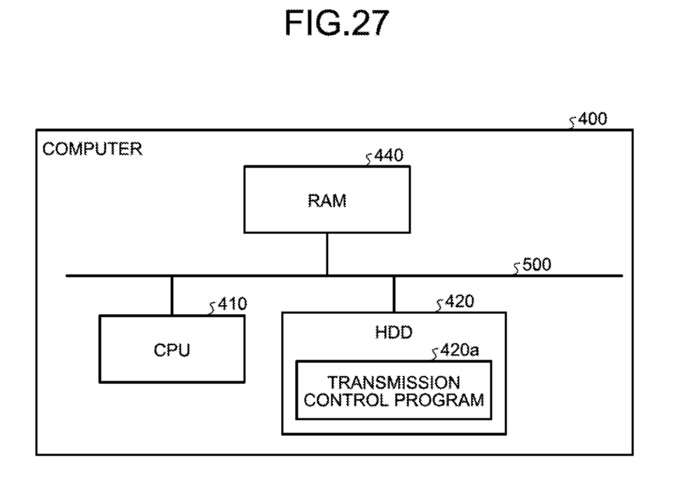

The various processing explained in the above-described embodiments can also be implemented by executing a program prepared in advance on a computer system such as a personal computer and a workstation. Thus, the following describes one example of a computer system that executes a program having the functions the same as those of the above-described embodiments. FIG. 27 is an explanatory diagram illustrating one example of a configuration of a computer that executes a transmission control program.

As illustrated in FIG. 27, a computer 400 includes a central processing unit (CPU) 410, a hard disk drive (HDD) 420, and a random access memory (RAM) 440. Each of these units 400 to 440 is connected via a bus 500.

In the HDD 420, stored in advance is a transmission control program 420a that exercises the functions the same as those of the reception unit 80, the storing unit 81, and the transmitting unit 82 of the measurement instrument 16 in the foregoing, or those of the reception unit 110, the collection unit 111, and the transmitting unit 112 of the mobile communications terminal 19 in the foregoing. The transmission control program 420a may be separated as appropriate.

The HDD 420 further stores therein a variety of information. For example, the HDD 420 stores therein an OS, and various data that is used for determining the order quantity.

The CPU 410 then, by reading out and executing the transmission control program 420a from the HDD 420, performs the operations the same as those of the various processing units in the embodiments. That is, the transmission control program 420a performs the operations the same as those of the reception unit 80, the storing unit 81, and the transmitting unit 82 or of the reception unit 110, the collection unit 111, and the transmitting unit 112.

The above-described transmission control program 420a does not necessarily need to be stored in the HDD 420 from the beginning.

For example, the program is kept stored in a “transportable physical medium” such as a flexible disk (FD), a CD-ROM, a DVD disk, a magneto-optical disk, and an IC card inserted into the computer 400. The computer 400 may then read out and execute the program from these.

Moreover, the program is kept stored in “another computer (or server)” connected to the computer 400 via a public line, the Internet, a LAN, a WAN, and the like. The computer 400 may then read out and execute the program from these.

According to one aspect of the embodiment of the present invention, the invention has an advantageous effect in that information used for health management can be provided even when the operation management is performed in a plural manner.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A measurement instrument comprising:
a processor configured to:
receive registration of user identification information and a plurality of transmission destinations; and
transmit a result of measurement that concerns health management measured by the measurement instrument to each of the transmission destinations registered in association with the registered user identification information.

2. The measurement instrument according to claim 1, wherein
the measurement instrument is a measurement instrument capable of a plurality of types of measurement concerning health management, and
the processor is configured to receive, for each of the transmission destinations, registration defining which type of measurement result is a measurement result to be a transmitting object.

3. The measurement instrument according to claim 1, wherein the processor is configured to transmit transmission data including an attribute of measurement result, identification information on a manufacturer of the measurement instrument, a device identification number of the measurement instrument, measurement time, a measurement result, and a measurement location to each of the transmission destinations.

4. The measurement instrument according to claim 1, wherein the processor is configured to receive registration of user identification information by reading a non-contact IC card in which the user identification information is stored.

5. The measurement instrument according to claim 1, wherein the processor is configured to:
store characteristics of a measurement result of a user in association with user identification information on the user; and
transmit a result of measurement that concerns health management in association with user identification information on a user whose result of measurement is closest to the characteristics of a measurement result stored in a storage.

6. A mobile communications terminal comprising:
a processor configured to:
collect, from a measurement instrument that stores therein a measurement result concerning health management in association with user identification information, a measurement result that is stored in association with specific user identification information; and
transmit the collected measurement result to a certain transmission destination in association with identification information indicative of a measurement instrument of an acquisition source of the measurement result and in association with the specific user identification information.

7. The mobile communications terminal according to claim 6, wherein the processor is configured to transmit positional information on which the measurement result has been collected.

8. The mobile communications terminal according to claim 6, wherein the processor is configured to:
collect travel information from an in-vehicle device fitted to a vehicle, the in-vehicle device acquiring the travel information; and
transmit the travel information to the certain transmission destination in association with the specific user identification information.

9. A mobile communications terminal comprising:
a processor configured to:
collect, from each of a plurality of measurement instruments that store therein a measurement result concerning health management in association with user identification information, a measurement result that is stored in association with specific user identification information; and
transmit the collected measurement result to a certain transmission destination in association with identification information indicative of each measurement instrument of an acquisition source of the measurement result and in association with the specific user identification information.
